(19) United States
(12) Patent Application Publication
(10) Pub. No.: US 2005/0056146 A1
(43) Pub. Date: Mar. 17, 2005

(54) Actuator having both a hydraulic mode and a mechanical mode of operation

(75) Inventor: Marc Quenerch'Du, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 10/917,370

(22) Filed: Aug. 13, 2004

(30) Foreign Application Priority Data
Sep. 12, 2003 (FR) 03 10736

(51) Int. Cl. F16J 15/18

(52) U.S. Cl. 92/165 PR

(57) ABSTRACT

The invention relates to an actuator comprising a body with a cylindrical cavity, and a rod extending through one end of the cavity, being secured with a piston mounted to slide axially in the cavity so as to define therein two hydraulic chambers, the actuator including additional means for extending the rod, which comprise: means for preventing the rod from rotating relative to the body of the actuator; a nut rigidly secured to the rod; a screw extending axially inside the cavity and co-operating with the nut; a drive shaft extending axially inside the cavity and being free to turn, the screw being mounted to slide without rotation along the shaft; and rotary drive means for driving the drive shaft.

The invention relates to an actuator having two modes of operation, namely a hydraulic mode and a mechanical mode.

### BACKGROUND OF THE INVENTION

Hydraulic actuators are known which comprise a body with a cylindrical cavity and a rod extending through one end of the cavity, being secured to a piston that is slidably mounted in the cavity so as to define two hydraulic chambers therein. Feeding fluid under pressure into one or the other of the chambers causes the rod to be extended or retracted.

That type of actuator is sometimes used in applications where it must be possible to extend the rod in all situations, even in the event of a hydraulic breakdown.

In that situation, there are various ways in which the rod can be extended. Firstly, it is possible to open both chambers and allow the weight of the load coupled to the rod to act. That is how the landing gear of an aircraft is extended in an emergency, for example.

However, that is possible only when the load does not have a position of stable equilibrium under the effect of gravity that corresponds to some intermediate position of the rod. Under such circumstances, gravity alone cannot bring the load into a final position corresponding to the extended position of the rod.

It is then necessary to provide additional means suitable for extending the rod. Such means may, for example, be of the mechanical type, such as a spring for extending the rod. The spring must be designed to be sufficiently powerful to enable the rod to be extended against resistive forces opposing such extension. The drawback of a spring is that it exerts a continuous force on the rod tending to extend it, and this force needs to be overcome in normal hydraulic operation in order to retract the rod.

The additional means for extending the rod may also be of the electrohydraulic type, such as an electrically powered pump arranged to inject fluid under pressure into the appropriate chamber of the actuator in order to be able to extend the rod. Nevertheless, that solution suffers from being complex and expensive.

The state of the art is illustrated by the documents GB-A-733 840, U.S. Pat. No. 3,029,659, and U.S. Pat. No. 2,730,994, which describes hydraulic actuators having an electrical emergency mode. Those actuators include a screw and a nut, one of which is secured to the rod while the other is rotated by an electric motor. Nevertheless, it should be observed that the element driven in rotation is axially stationary, which requires a reversible connection between the nut and the screw in order to allow the rod to be moved in hydraulic mode.

To complete the technological background, mention can also be made to document DE-A-39 10814 which describes the general structure of a telescopic actuator functioning in electrical mode only.

### OBJECT OF THE INVENTION

An object of the invention is to provide an actuator that does not have the above-mentioned drawbacks.

### BRIEF SUMMARY OF THE INVENTION

The invention provides an actuator comprising a body with a cylindrical cavity defined axially by two ends, and a rod extending through one of the ends of the cavity, being secured to a piston mounted to slide axially within the cavity so as to define therein two hydraulic chambers, the actuator being fitted with additional means for extending the rod, which, according to the invention, comprise:
means for preventing the rod from rotating relative to the body of the actuator;
a nut rigidly secured to the rod;
a screw extending axially inside the cavity and co-operating with the nut;
a drive shaft extending axially inside the cavity and being free to turn, the screw being mounted to slide without rotation along the shaft; and
rotary drive means for driving the drive shaft.

Thus, during operation in hydraulic mode, the nut slides with the rod and drives the screw which slides on the drive shaft. Hydraulic operation is therefore not impeded by the presence of the emergency extender means.

During operation in mechanical mode, when the supply of fluid under pressure has failed, or is not available, both hydraulic chambers are connected to hydraulic return, while the drive shaft is set into rotation. The screw is thus rotated. If the screw is not bearing against the end of the cavity opposite from the end through which the rod passes, its rotation causes it to move axially by bearing against the nut which is held stationary in the axial direction because of internal friction or because of the inertia of the load coupled to the actuator. This displacement continues until the screw comes into abutment against the end opposite from the end through which the rod passes. Once the screw has come into abutment, continued rotation of the screw causes the nut to move axially in the opposite direction, which corresponds to extending the rod.

Two modes of operation are thus obtained for the actuator, a hydraulic mode and a mechanical mode, which modes can be implemented as alternatives depending on the availabilities of sources of hydraulic or mechanical energy.

Preferably, in order to co-operate with the rotary drive means mounted outside the cavity, the drive shaft extends through an end of the cavity that is opposite from the end through which the rod extends.

Thus, the drive means is sheltered from the hydraulic fluid filling the cavity.

In a preferred embodiment of the invention, the rotary drive means are constituted by an electric motor secured to the actuator.

In a particular embodiment of the invention, the piston is made integrally with the rod, the nut being fitted in a housing of the rod.

Preferably, the actuator includes an axial abutment of the screw against the end of the cavity opposite from the end through which the rod passes.

Advantageously, the rod is hollow and the screw extends inside the rod. Also advantageously, the screw itself is hollow, and the drive shaft extends inside the screw, being connected thereto by fluting.

### BRIEF DESCRIPTION OF THE DRAWINGS

The invention will be better understood in the light of the following description given with reference to the accompanying drawings, in which:

FIG. 1 is a section view of an actuator of the invention in which the rod is shown in its retracted position;

FIG. 2 is a view analogous to FIG. 1, in which the rod is shown in an intermediate position during operation in hydraulic mode (in this case normal mode); and

FIG. 3 is a view analogous to FIG. 1, in which the actuator is shown in mechanical mode operation (in this case emergency mode).

### DETAILED DESCRIPTION OF THE INVENTION

With reference to FIG. 1, the actuator of the invention comprises a body including a blind jacket 1 whose inside forms a cylindrical cavity C that is closed in leaktight manner by an end wall 2 and by a plug 3. The actuator includes a hollow rod 4 which extends axially inside the cavity C to pass in leaktight manner through the plug 3, which acts as a bearing. The rod 4 is terminated inside the cavity C by an end forming a piston 5, which acts inside the cavity C to define an extender chamber S and a retractor chamber R.

The rod 4 includes a housing 6 for a nut 7 which is held securely in said housing 6, such that the rod 4 and the nut 7 are rigidly secured to each other. A hollow screw 8 extends axially inside the rod 4 to co-operate with the nut 7 via a helical type connection. A drive shaft 9 extends axially inside the screw 8 and passes in leaktight manner through the end wall 2 to open out into a casing 11 in which the drive shaft 9 is supported by two ball bearings 10 enabling the drive shaft 9 to rotate. The casing 11 defines a housing for stepdown gearing 12, in this case comprising two intermediate shafts transferring rotary drive to the drive shaft 9 from an electric motor 13 secured to the casing 11. The screw 8 is mounted on the drive shaft 9 to slide without rotating along it, in this case by means of a connection via fluting (not shown). Rotation of the drive shaft 9 thus causes the screw 8 to rotate.

Antirotation means (not shown) prevent the rod 4 from rotating relative to the jacket 1. The antirotation means may be internal to the actuator, but they could also be external to the actuator, as in the situation where the rod and the actuator body are coupled to loads via linkages that prevent the rod from rotating relative to the body.

The actuator of the invention operates as follows. In hydraulic operation, hydraulic ports (not shown) enable fluid under pressure to be fed into one of the chambers S and R, while the other one of the chambers S and R is connected to a hydraulic return in order to enable the hydraulic fluid contained in said chamber to be expelled.

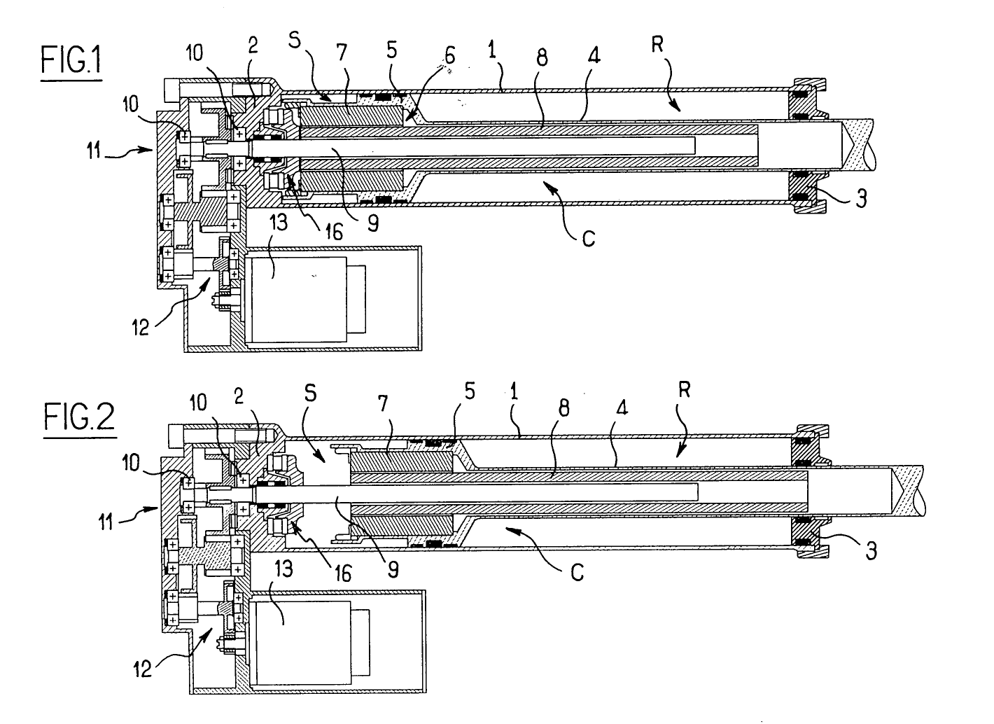

As can be seen in FIG. 2 which shows the actuator during hydraulic mode operation, the axial displacement of the rod 4 under the effect of the fluid under pressure leads to corresponding displacement of the screw 8 driven by the nut 7, the screw 8 sliding freely on the drive shaft 9 which does not turn.

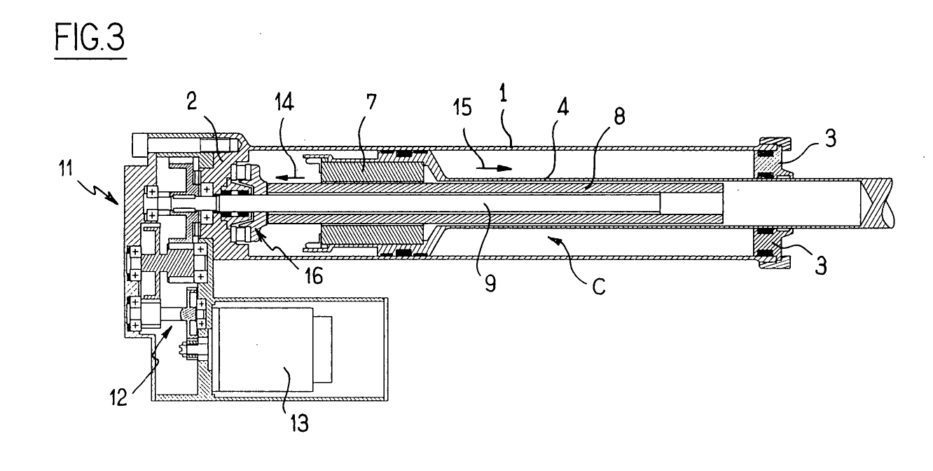

During operation in mechanical mode, the ports of the chambers S and R are connected to the hydraulic return, while the electric motor 13 is controlled to cause the drive shaft 9 to rotate. Starting from an intermediate position such as that shown in FIG. 4, such rotation initially causes the screw 8 to move axially in the direction 14 shown in FIG. 3. The rod 4 is held stationary by the friction to which the rod 4 is subjected, or by the inertia exerted on the actuator by the loads to which the rod is coupled, thereby forcing the screw 8 to move axially, bearing against the nut 7. The motor 13 is naturally controlled so as to turn in the direction which causes the screw 8 to move in the direction 14.

Then, once the screw 8 comes into abutment against the end wall 2, as shown in FIG. 3, continued rotation of the screw 8 causes the nut 7 to move, and thus moves the rod 4 in the direction 15 corresponding to the rod 4 being extended, against the opposing forces acting on the rod 4. These forces are transmitted to the end wall by the screw 8 bearing thereagainst. Advantageously, the end wall 2 is fitted with an axial abutment 16 in order to enable the screw 8 to rotate easily while pressing thereagainst.

The rod 4 can thus be extended hydraulically or mechanically.

The invention is not limited to the particular features of the invention as described above, but on the contrary it covers any variant coming within the ambit of the invention as defined by the claims.

In particular, although it is stated that the means for driving the drive shaft 9 in rotation are constituted by an electric motor, it would also be possible to provide a hydraulic motor, or even an emergency handle.

Although it is stated that the means for driving the drive shaft 9 in rotation are permanently mounted on the actuator, they could be provided independently of the actuator.

Although it is stated that the means for driving the drive shaft 9 in rotation are mounted outside the cavity, said means could be mounted inside the cavity. In which case the rotary drive means would be immersed in the hydraulic fluid.

Although it is stated that the drive shaft 9 is coupled to the electric motor 13 via stepdown gearing 12, the drive shaft could be directly engaged with the motor.

Although it is stated that the rod 4 is hollow, the invention is also applicable to an actuator having a solid rod. The stroke in emergency operation mode is then limited to the length of the nut.

Although it is stated that the screw is hollow in order to receive the drive shaft, thereby enabling the stroke of the rod 4 to be maximized, the invention is also applicable to an actuator having a solid screw. A connection portion between the drive shaft 9 and the screw 8 is then provided at the end of the screw, thereby correspondingly limiting the stroke of the rod 4.

Although it is stated that the screw 8 is mounted to slide without rotation on the drive shaft 9 by means of fluting, it is possible, more generally, to provide any other type of sliding connection, such as a finger or a key secured to one of those two elements and extending into a longitudinal slot in the other element.

Although it is stated that the rod 4 is integral with the piston 5, the piston could be fitted to the rod.

1. An actuator comprising a body with a cylindrical cavity, and a rod extending through one end of the cavity, being secured with a piston mounted to slide axially in the cavity so as to define therein two hydraulic chambers, the actuator including additional means for extending the rod, which comprise:
means for preventing the rod from rotating relative to the body of the actuator;
a nut rigidly secured to the rod;
a screw extending axially inside the cavity and co-operating with the nut;
a drive shaft extending axially inside the cavity and being free to turn, the screw being mounted to slide without rotation along the shaft; and
rotary drive means for driving the drive shaft.

2. An actuator according to claim 1, wherein the drive shaft extends through an end of the cavity opposite from the end through which the rod passes, in order to be driven in rotation by the rotary drive means mounted outside the cavity.

3. An actuator according to claim 2, wherein the rotary drive means are constituted by an electric motor secured to the actuator.

4. An actuator according to claim 1, wherein the piston is formed integrally with the rod, the nut being fitted in a housing of the rod.

5. An actuator according to claim 1, wherein the actuator includes an axial abutment for the screw against an end of the cavity opposite from the end through which the rod passes.

6. An actuator according to claim 1, wherein the rod is hollow, and wherein the screw extends in the rod.

7. An actuator according to claim 1, wherein the screw is hollow, and wherein the drive shaft extends inside the screw, being connected thereto by fluting.
